(19) United States
(12) Patent Application Publication
(10) Pub. No.: US 2005/0114304 A1
(43) Pub. Date: May 26, 2005

(54) Solution network excursion module

(76) Inventors: Larry W. White, Austin, TX (US); James Hunter Enis, Round Rock, TX (US)

Correspondence Address: Stephen A. Terrile, HAMILTON & TERRILE, LLP, PO Box 203518, Austin, TX, 78720, US

(21) Appl. No.: 10/696,942

(22) Filed: Oct. 30, 2003

(51) Int. Cl. G06F 17/60

(52) U.S. Cl. 707/3; 705/7

(57) ABSTRACT

A method for identifying excursions to general solutions provided by a solution network which includes identifying excursions to a general solution on a system basis, saving the excursions within the solution network on a system basis, and when accessing the solution network, searching the solution network to determine whether an excursion solution exists.

### BACKGROUND OF THE INVENTION

The present invention relates to the field of customer support and more particularly to knowledge management systems for use with customer support systems.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems such as home and business computers, the provision of timely and efficient diagnostic, support, and maintenance services to end users has become an important issue for manufacturers and sellers of computer systems. It is not uncommon for end users, especially new users, or experienced users attempting to add or reconfigure existing systems, to experience difficulties with their systems. For example the system might lock up (often referred to as freezing up or hanging). Also for example, a peripheral of the computer system, such as a hard drive, disk drive, or printer, may not function properly. In other cases, the computer system may not recognize the peripheral. The solution to these sorts of problems may range from simply turning on power to the affected peripheral, reconnecting the affected peripheral, reconfiguring the computer system hardware or software, or installing a necessary software patch for the affected peripheral.

To diagnose and correct an issue, users typically have had to consult user's manuals that were included with the purchase of the system or peripheral. These manuals typically include troubleshooting tables or guides that attempt to diagnose a user's problem on the basis of symptoms recognized by the user. The effectiveness of the user's manual in assisting the users in identifying and correcting the problems encountered depends in large part on the skill of the computer user and the clarity and completeness of the user's manual. An inexperienced user may have difficulty in locating the source of the problem and in following the often confusing instructions in the user's manual. Moreover, user's manuals are often deficient in that they do not address every difficulty encountered by the user.

As an alternative or in addition to consulting a user's manual, a user experiencing difficulty with a system may consult diagnostic and support software stored locally on the system. The effectiveness of locally stored diagnostic software is limited in that the software programs generally display text files that have information similar to that found in user's manuals. As a result, users attempting to diagnose computer system problems through locally stored software programs face limitations similar to those faced by users attempting to diagnose system problems through a user's manual.

As another alternative, users may have access to a support or help line. A support or help line requires that the user contact a support technician or specialist at a central site. The support technician listens to the user's symptoms and attempts to diagnose the problem. This process often involves the support technician stepping the user through a series of diagnostic tests. If appropriate, the support technician may provide the user with instructions or tips for correcting the problem. The effectiveness of interpersonal diagnostic and support services of this sort depends in large part on the skill of the user being assisted. Regardless of the skill and knowledge of the support technician, the user will nevertheless have to describe correctly the problem being experienced, assist the support technician in diagnosing the problem, and perform the fix or correction suggested by the support technician.

An issue relating to the support system relates to the ability identifying when there may be exceptions to rendering solutions based on variables like the customer system, model and operating system. For example, if a customer calls in with a battery will not hold a charge symptom, the normal solution might be to order a new battery. However, there might be an exception case where a certain number of systems escaped manufacturing with a faulty motherboard that can cause the battery to short out after a certain amount of time. If the support system provided the normal solution for this symptom, ordering a battery would result in several repeat dispatches because the motherboard would continue to short out the battery. The correct solution for the systems with the short issue would be to order a battery and a motherboard.

In known support systems, exceptions may be handled by issuing emails or handing out paper notes to all technicians. The support provider then hopes that when an exception situation is encountered by a technician, the technician remembers the correct solution.

### SUMMARY OF THE INVENTION

In accordance with the present invention, a knowledge management system is provided which includes the ability to flag predetermined systems that have a known exception and render an exception solution. Exceptions may be identified by manufactured date, component supplier and model. In one embodiment, the knowledge management system creates and maintains a table of service tags with known exceptions. When customer enters the service tag into the support network search tool, the knowledge management system first checks the exception database for potential exception matches. If an exception is found, the exception solution is rendered. If no exception is found then a normal support search occurs and the identified solution is provided. Additionally, the support network includes support for identifying exception solutions without requiring information technology (IT) intervention.

In one embodiment, the invention relates to a method for identifying excursions to general solutions provided by a solution network which includes identifying excursions to a general solution on a system basis, saving the excursions within the solution network on a system basis, and when accessing the solution network, searching the solution network to determine whether an excursion solution exists.

In another embodiment, the invention relates to an apparatus for identifying excursions to general solutions provided by a solution network. The apparatus includes means for identifying excursions to a general solution on a system basis, means for saving the excursions within the solution network on a system basis, and means for searching the solution network to determine whether an excursion solution exists when accessing the solution network.

In another embodiment, the invention relates to a solution network which includes a knowledge repository, an excursion identifying module, and a search module. The knowledge repository stores information regarding general solutions to issues and information relating to excursions to general solutions. The excursions are searchable on a system basis. The excursion identifying module identifies excursions to the general solutions on a system basis. The search module searches the solution network to determine whether an excursion solution exists when accessing the solution network.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a solution environment.

FIG. 2 shows a block diagram of a solution network.

FIG. 3 shows a flow chart of the operation of an excursion module

FIG. 4 shows a block diagram of a process view of the interaction within the solution network.

### DETAILED DESCRIPTION

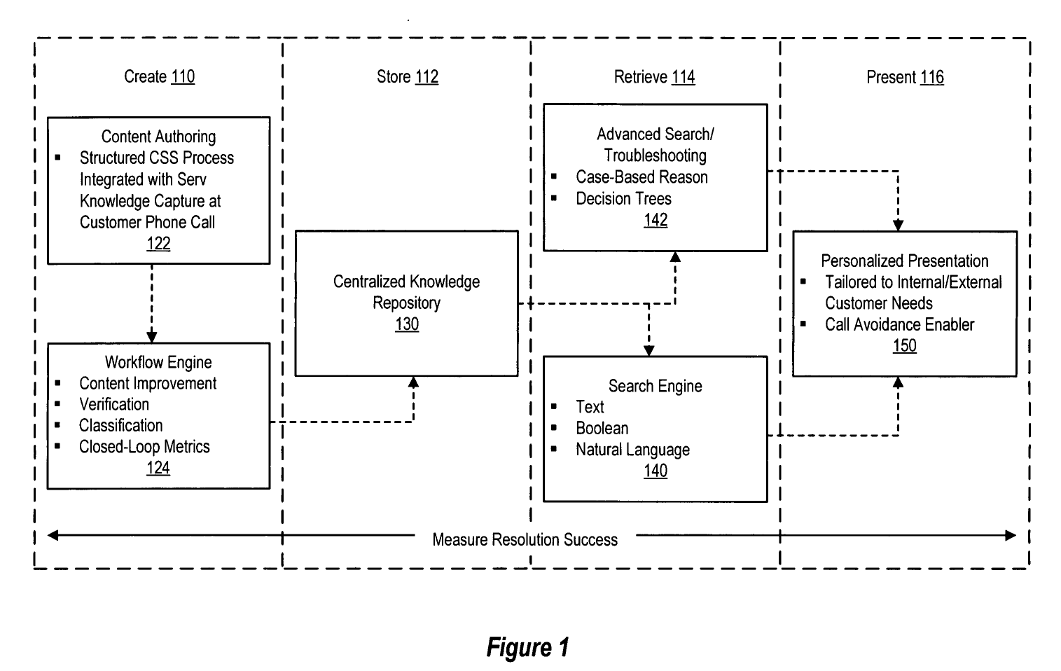

Referring to FIG. 1, a block diagram of the solution environment 100 is shown. More specifically, the solution environment 100 includes a create portion 110, a store portion 112, a retrieve portion 114 and a present portion 116.

The create portion 110 provides an environment in which knowledge is created. More specifically, the create portion 110 includes a content authoring portion 120 and a workflow engine portion 122. The content authoring portion provides a structured customer service and support (CSS) process which is integrated with a solution network server. The content authoring portion 122 also includes a knowledge capture portion which enables knowledge capture during communication with a customer. The workflow engine portion 124 provides a content improvement function, a knowledge verification function, a knowledge classification function as well as closed loop metrics for knowledge creation.

The store portion 112 provides the environment in which knowledge is stored. More specifically, the store portion 112 includes a centralized knowledge repository 130 in which knowledge that is created in the create portion 110 is stored.

The retrieve portion 114 provides the environment in which knowledge is retrieved. More specifically, the retrieve portion includes a search engine 140 in which various types of searches may be performed on the centralized knowledge repository 130. The searches may be in the form of, e.g, text searches, Boolean searches or natural language searches, etc. The retrieve portion also includes an advanced search and troubleshooting portion 142 which provides case based reason function as well as a decision tree function.

The present portion 116 provides the environment in which support knowledge is presented to a customer. More specifically, the present portion 116 provides a personalized presentation 150 of support knowledge. This information may be tailored to the internal or external customer needs. Providing a personalized presentation 150 becomes a call avoidance enabler in that a personalized presentation may enable a customer to obtain a answer to a problem without the need for a specific call to customer support.

The solution environment streamlines resource usage and enhances knowledge mining capabilities by eliminating the need for a third party or disconnected content creation group. The environment enables content creation applicable to the customer and business needs by integrating the content creation process and the call center technician phone intake process. The technical information is removed from a customer management tool and placed in a repository that can be used by other technicians. The environment thus enables continual use which allows the technical repository to evolve and grow while focusing knowledge mining on confirmed applicable incidents as compared to a perceived need.

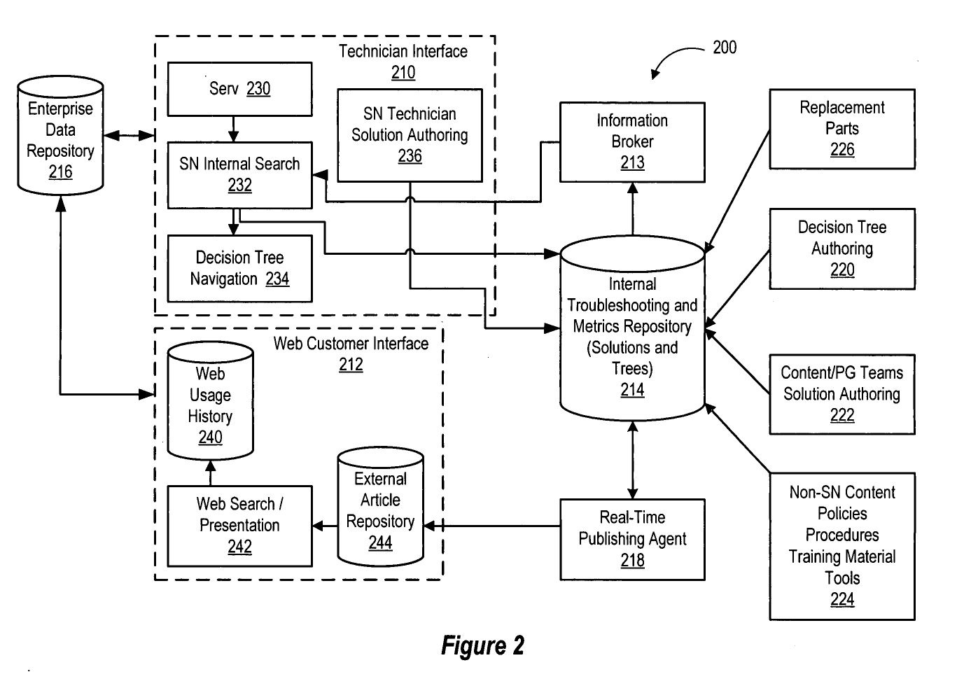

Referring to FIG. 2, a block diagram of a solution network 200 which instantiates the solution environment is shown. More specifically, the solution network 200 includes a technician interface module 210, a customer interface module 212, an information broker 213, an internal repository 214, an enterprise data repository 216, a real time publishing agent 218, a decision tree authoring module 220, a content/PG teams solution authoring module 222, a Non-solution network (Non-SN) content module 224 and a replacement parts module 226. The technician interface module 210 is coupled to the enterprise data repository 216, to the customer interface module 212 and to the information broker 213 as well as to the internal repository 214. The internal repository 214 is coupled to the information broker 213 and the real time publishing agent 218 as well as the decision tree authoring module 220, the content/PG teams solution authoring module 222, the Non-solution network (Non-SN) content module 224 and the replacement parts module 226. The real time publishing agent 218 is coupled to the customer interface 212.

The technician interface module 210 provides the user interface function between the technician and the solution network system 200. The customer interface module 212 provides the interface function for customers to the solution network system 200. The information broker 213 accesses information from the internal repository 214 and provides this information to the technician interface 210. The internal repository 214 provides a repository for troubleshooting solutions (both solutions and solution trees) as well as metrics relating to the solution network. The troubleshooting solutions may include articles, decision trees, and policies. The information broker 213 determines a best answer for a user based upon the user's answers to questions presented by the technician. The solution may be an action, such as rebooting the customer system, or the solution may be an actual part that needs to be replaced on the customer system. In the case of a part, the part number may be listed as the solution within the internal repository 214.

The enterprise data repository 216 is a customer database which includes histories on a customer including what system the customer has purchased, the components included with the system, profile history (i.e., contact information) as well as prior service history, prior rendered solutions and prior web support activity. Linking this customer information with the solution network 200 enables generating a solution faster and with fewer questions to the customer. Additionally, providing the component information to the solution network 200 enables solutions to be rendered that may be component specific. Additionally, maintaining service history on a customer basis enables the solution network 200 to tailor customer specific solutions as well as monitoring whether a particular customer is trying to take advantage of the service provider by obtaining excess replacement components.

The real time publishing agent 218 enables the solution network 200 to release knowledge immediately while the solution network 200 is running. Thus, technicians and customers have access to solutions stored within the repository 214 as soon as the solution is released, without having to wait for a new publish cycle to occur.

The technician interface 210 includes a server module 230, an internal search module 232, a decision tree navigation module 234 and a SN technician solution authoring module 236. The server module 230 provides the service on which the technician interface 210 resides. The SN internal search module 232 receives customer described issue and searches the internal repository 214 for possible solutions. The search module 232 systematically converts how a customer describes an issue into searchable keywords. For example, if a customer call and informs the technician that the customer system will not turn on, the search module may convert this to a technical search for solutions relating to a “No Power on Self Test (POST)” condition. The decision tree navigation module 234 controls the way that branches on a solution network decision tree are rendered. The technician solution authoring module 236 enables a technician to modify or augment a solution provided by the repository in real time (i.e., provide the modification or augmentation to the repository while the technician is interacting with a customer). A particular line of business can see these augmentations either immediately or after release from incubation. The level of incubator at which the line of business is notified is customizable depending on the desires of each line of business.

The customer interface 212 is, for example a web customer interface, which is accessible via the internet. The customer interface 212 includes a web usage history module 240, a web search and presentation module 242 and an external article repository 244. The web usage history module 240 maintains a history of the interaction between a customer and the solution network 200. This history is maintained so that if an issue is forwarded from the customer interface 212 to the technician interface 210, the technician can easily determine what questions or answers have already been tried by the user when attempting self-help via the customer interface 212 before enlisting technician assisted support. The web search/presentation module 242 is the module with which the customer interacts when accessing the customer interface 212. The external article repository 244 is a repository of documents that have been released for public access.

The decision tree authoring module 220 stores information within the repository 214 which enables knowledge to be linked together in a process oriented fashion. The content/PG teams solution authoring module 222 enables the authoring of stand alone knowledge solutions and applies the appropriate attributes to this knowledge. The Non-solution network (Non-SN) content module 224 stores information regarding policies and procedures within the repository 214. For example, a particular customer might have certain associated business policies that a technician might be expected to apply. The Non-SN content module 224 thus essentially applies a filter to particular customer situations. The Non-SN content module 224 also includes training material for training support technicians. This training material includes extra support detail than is provided to technicians who are interacting with customers. The Non-SN content module 224 also provides a conduit into other support tools that might not have been stored within the repository 214. The replacement parts module 226 develops solutions relating to which replacement parts are associated with particular systems.

The solution network 200 includes the ability to flag predetermined systems that have a known solution exception (i.e., an excursion) and render an exception solution. Exceptions may be identified by manufactured date, component supplier and/or model. In one embodiment, a system unique identifier such as a service tag may be used. The service tag sets forth the configuration of a particular unique system and thus provides information regarding all components that a particular system includes. The solution network 200 creates and maintains a table of service tags with known exceptions within the repository 214. When customer enters the service tag into the support network search tool, the solution network 200 first checks the exception database for potential exception matches. If an exception is found, the exception solution is rendered. If no exception is found then a broad based support search occurs and the identified solution is provided. The support network includes support for identifying exception solutions simply by entering excursion information into the excursion database and thus may identify exception solutions without requiring information technology (IT) intervention.

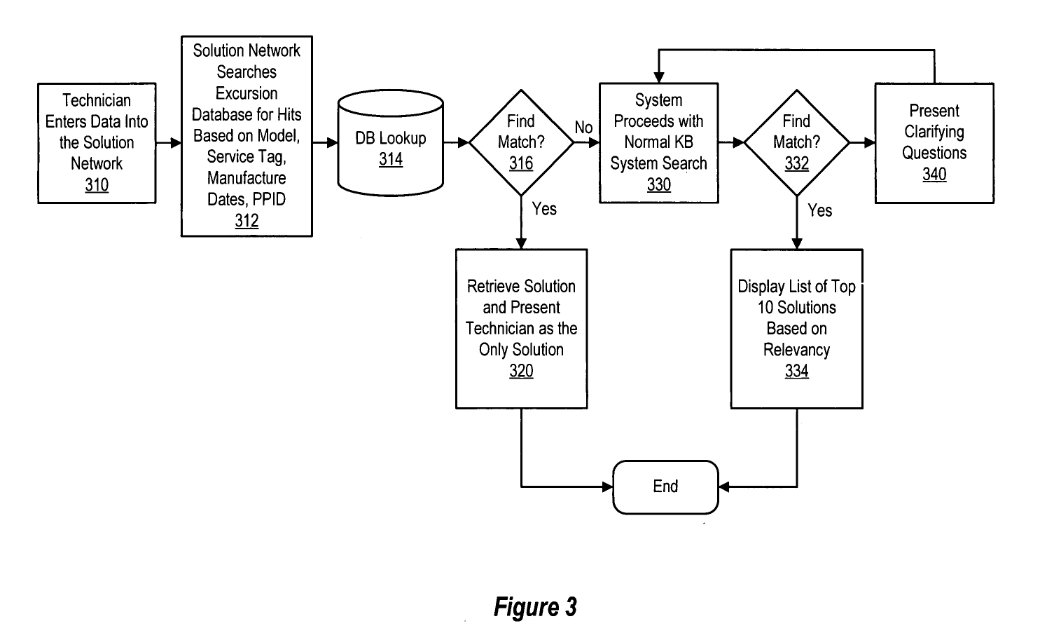

Referring to FIG. 3, a flow chart of the operation of an excursion module 300 is shown. More specifically, the operation of the excursion module 300 starts with a technician entering data into the solution network 200 at step 310. The solution network 200 initiates a search of an excursion database within the internal repository 410 for hits based upon the system model number, service tag, manufacture dates, and/or piece part identification (PPID), etc. at step 312 and performs a database lookup at step 314. The solution network 200 then determines whether a match to the excursion criteria was found at step 316 (i.e., is there an excursion condition). If there is a match of the excursion criteria, then the solution network 200 retrieves the excursion solution at step 320 and presents this solution to the technician as the only solution for the user's issue and the execution of the excursion module 300 completes.

If there is not a match of the excursion criteria, then the solution network 200 proceeds with a knowledge base (KB) system search at step 330. If the solution network 200 finds a match to the search as determined by step 332, then the solution network 200 presents a list of the top 10 solutions to the issue based upon relevancy at step 334 and the execution of the excursion module 300 completes. If the solution network 200 does not find a match, then the solution network 200 presents clarifying questions to the individual that accessed the excursion module at step 340 and the solution network proceeds with another database search at step 330.

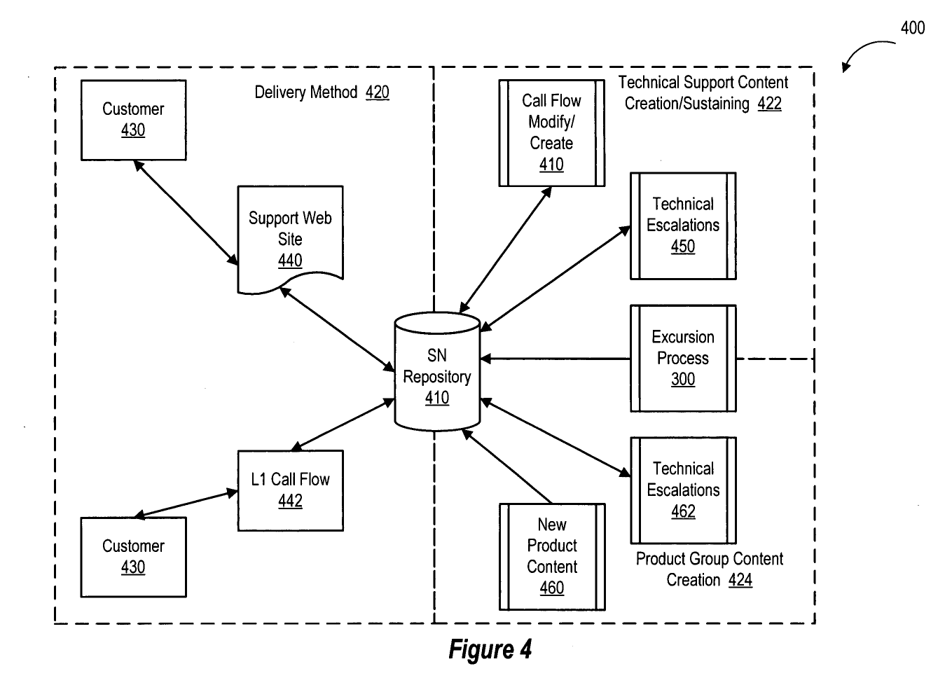

Referring to FIG. 4, a block diagram of a process view of the interaction within the solution network 200 is shown. More specifically, the solution network 200 provides the link between the knowledge delivery portion 420, the technical support content creation/sustaining portion 422 and the product group content creation portion 424.

The solution network 200 is coupled to a customer 430 via a support web site 440 or via a first level of support call flow 442. Call flow within the solution network 200 is tiered. E.g., a first level support technician may receive an initial support call. If this technician can not solve the issue, then the call may be escalated to another more sophisticated technician based upon the difficulty of the issue. The solution network 200 is coupled to the technical support content creation/sustaining portion 422 and more particularly to the call flow modify/create module 410 as well as to a technical escalations module 450 and an excursion process module 452. The solution network 200 is coupled to the product group content creation portion 424 and more particularly to a new product content module 460 and a product group technical escalations module 462 as well as the excursion process module 300.

The technical escalations module 450 enables the escalation of an issue from a first level skill level technician to a second level skill level technician. The escalation enables a skill based routing of the issue based upon questions that have been previously asked of the customer. Upon escalation of an issue, the second level skill level technician may generate or modify a document to address the issue that was escalated. The call flow modify/create module 410 is the module via which the technical support technicians create or sustain content within the solution network 200.

The product group content creation portion 424 is the portion via which product group engineers create content that is provided to the solution network 200. The product group technical escalations module 462 enables the escalation of an issue from a second level skill technician to a product group engineer. The engineer then creates a new document for the issue via the product group content creation portion 424 that is then provided to the solution network 200.

The excursion process module 452 handles exceptions to the solution process at a platform or system level to address when a specific system, a specific component or specific software or some combination of a specific system, specific component and specific software may require a unique solution.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also, for example, the above-discussed embodiments include software modules that perform certain tasks. The software modules discussed herein may include script, batch, or other executable files. The software modules may be stored on a machine-readable or computer-feadable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

### Other Embodiments

Other embodiments are within the following claims.

1. A method for identifying excursions to general solutions provided by a solution network comprising:
identifying excursions to a general solution on a system basis;
saving the excursions within the solution network on a system basis; and,
when accessing the solution network, searching the solution network to determine whether an excursion solution exists.

2. The method of claim 1 further comprising:
storing the excursion exception within the solution network based upon a unique system identifier.

3. The method of claim 2 wherein:
the unique system identifier is a service tag.

4. The method of claim 1 further comprising:
storing the excursion exception within the solution network based upon a part identifier.

5. The method of claim 1 further comprising:
storing the excursion exception within the solution network based upon a system model identifier.

6. The method of claim 1 further comprising:
storing the excursion exception within the solution network based upon a system manufacture date.

7. The method of claim 1 further comprising:
searching the solution network for general solutions when no excursion solution exists, the searching the solution network to determine whether an excursion solution exists being performed before searching to solution network for general solutions.

8. The method of claim 1 wherein:
the system includes an information handling system.

9. An apparatus for identifying excursions to general solutions provided by a solution network comprising:
means for identifying excursions to a general solution on a system basis;
means for saving the excursions within the solution network on a system basis; and,
means for searching the solution network to determine whether an excursion solution exists when accessing the solution network.

10. The apparatus of claim 9 further comprising:
means for storing the excursion exception within the solution network based upon a unique system identifier.

11. The apparatus of claim 10 wherein:
the unique system identifier is a service tag.

12. The apparatus of claim 9 further comprising:
means for storing the excursion exception within the solution network based upon a part identifier.

13. The apparatus of claim 9 further comprising:
means for storing the excursion exception within the solution network based upon a system model identifier.

14. The apparatus of claim 9 further comprising:
means for storing the excursion exception within the solution network based upon a system manufacture date.

15. The apparatus of claim 9 further comprising:
means for searching the solution network for general solutions when no excursion solution exists, the searching the solution network to determine whether an excursion solution exists being performed before searching to solution network for general solutions.

16. The apparatus of claim 9 wherein:
the system includes an information handling system.

17. A solution network comprising:
a knowledge repository, the knowledge repository storing information regarding general solutions to issues, the knowledge repository storing information relating to excursions to general solutions, the excursions being searchable on a system bases;
an excursion identifying module, the excursion identifying module identifying excursions to the general solutions on a system basis;
a search module, the search module searching the solution network to determine whether an excursion solution exists when accessing the solution network.

18. The solution network of claim 17 wherein:
the excursions are identifiable based upon a unique system identifier.

19. The solution network of claim 18 wherein:
the unique system identifier is a service tag.

20. The solution network of claim 17 wherein:
the excursions are identifiable based upon a part identifier.

21. The solution network of claim 17 wherein:
the excursions are identifiable based upon a system identifier.

22. The solution network of claim 17 wherein:
the excursions are identifiable based upon a system manufacture date.

23. The solution network of claim 17 further comprising:
a general search module, the general search module searching the solution network for general solutions when no excursion solution exists, the searching the solution network to determine whether an excursion solution exists being performed before searching to solution network for general solutions.

24. The solution network of claim 17 wherein:
the system includes an information handling system.
